(19) United States
(12) Patent Application Publication
(10) Pub. No.: US 2023/0352214 A1
(43) Pub. Date: Nov. 2, 2023

(54) METHOD OF MANUFACTURING WIRE COVERING MATERIAL FOR PREVENTION OF SPILLOVER LOSS DURING TRANSMISSION OF HIGH FREQUENCY OR ULTRA HIGH FREQUENCY SIGNAL

(71) Applicant: TRUSVAL TECHNOLOGY CO., LTD., JHUNAN TOWNSHIP (TW)

(72) Inventor: SHIH-PAO CHIEN, JHUNAN TOWNSHIP (TW)

(21) Appl. No.: 17/661,403

(22) Filed: Apr. 29, 2022

(51) Int. Cl. H01B 13/22; H01B 13/06; C08K 7/00; C09D 7/40

(52) U.S. Cl. CPC H01B 13/22; H01B 13/06; C08K 7/00; C09D 7/70; C08K 2201/011; C08K 2201/003

(57) ABSTRACT

A method of manufacturing wire covering materials for prevention of spillover loss during transmission of high frequency or ultra high frequency signals is revealed. First compositing high insulating ceramic materials having flake structure with polymers and then forming a functional dielectric layer with no gap, no micropore, and low dielectric constant by a manufacturing process. Thereby the dielectric layer is used to cover various types of wires, or connector plugs and sockets for prevention of spillover loss during transmission of high frequency or ultra high frequency signals.

### BACKGROUND OF THE INVENTION

### Field of the Invention

The present invention relates to a method of manufacturing wire covering materials for prevention of spillover loss during transmission of high frequency or ultra high frequency signals, especially to a method of manufacturing wire covering materials for prevention of spillover loss during transmission of high frequency or ultra high frequency signals by using a functional dielectric layer to cover various types of wires, or connector plugs and sockets.

### Description of Related Art

Along with prosperous development of high technology, the size of passive electronic components is minimized, becoming more intense per unit area, and having higher performance. Thus requirements for quality of passive electronic components are increasing year by year.

A passive electronic component does not generate power, but it has the effect of dissipate, store, and/or release electricity. Examples of passive electronic components are capacitors, resistors, inductors, and so on. The passive electronic components are connected with active electronic components to form a complete circuit. For insulation, wires and connectors used for connection the passive electronic components with the active electronic components are covered in plastic materials.

Although the plastic materials mentioned above are widely used to form coatings around various types of wires and connectors for insulation and protection, they cause significant spillover loss during transmission of high frequency signals.

Thus there is room for improvement and there is a need to provide novel materials for prevention of spillover loss during transmission of high frequency or ultra high frequency signals.

### SUMMARY OF THE INVENTION

Therefore, it is a primary object of the present invention to provide a method of manufacturing wire covering materials for prevention of spillover loss during transmission of high frequency or ultra high frequency signals by using a functional dielectric layer to cover various types of wires, or connector plugs and sockets.

In order to achieve the above object, a primary object of the present invention to provide a method of manufacturing wire covering materials for prevention of spillover loss during transmission of high frequency or ultra high frequency signals according to the present invention includes the following steps.
A. getting ceramic materials having flake structure: getting high insulating ceramic materials having flake structure in micron-scale or nano-scale. The flake structure has a flake diameter ranging from 0.5 μm to 10 μm and contains 1 to 10 layers each of which having a thickness of 1 nm-3 nm;
B. compositing: carrying out composition of the ceramic materials having the flake structure with polymers;
C. obtaining functional dielectric layer: forming a functional dielectric layer with no gap, no micropore, and low dielectric constant by a manufacturing process.

Preferably, in the step A, the flake structure of the high insulating ceramic materials is cubic crystal or pseudocubic crystal.

Preferably, in the step A, a flake diameter of the flake structure is 5 μm.

Preferably, in the step A, the flake structure contains 1 to 3 layers.

Preferably, in the step A, a thickness of the respective layers of the flake structure is 1.5 nm-2 nm.

Preferably, in the step B, in-situ composition of the ceramic materials having the flake structure with non-polar polymers, or composition of the ceramic materials having the flake structure with polymers is performed.

Preferably, in the step B, the composition of the flake structure with the polymers is carried out by a mixer to get paste, granulation, or plastic pellets.

Preferably, in the step B, a solid content of the paste, granulation, or plastic pellets contains at least 50% the high insulating ceramic materials having the flake structure.

Preferably, in the step B, a solid content of the paste, granulation, or plastic pellets contains 98% the high insulating ceramic materials having the flake structure.

Preferably, in the step B, the paste is prepared by a mixture of the ceramic materials having the maximum diameter of 60 nm with a non-polar dispersant treated by ball milling dispersion for at least 8 hours.

Preferably, in the step B, time for the ball milling dispersion is 10 hours.

Preferably, in the step B, the paste is formed by the micron-scale ceramic materials having a flake diameter ranging from 110 nm to 1500 nm mixed with a non-polar dispersant and then treated by ball milling dispersion for at least 3 hours.

Preferably, in the step B, the flake diameter of the ceramic materials ranges from 960 nm to 1100 nm.

Preferably, in the step B, time for the ball milling dispersion is 4 hours.

Preferably, in the step C, the functional dielectric layer is gotten by the manufacturing process such as coating, blow molding, die casting, and injection molding.

Preferably, in the step C, the functional dielectric layer is like plastic.

Preferably, in the step C, viscosity of paste for manufacturing the functional dielectric layer is adjusted by solvents according to requirements for applications to form a film. A thickness of the film formed after curing is at least 6 μm while an initial temperature of the curing of the film is 100° C.-200° C. and the initial temperature is maintained at least one minute.

Preferably, in the step C, an initial temperature of the curing of the film is 150° C.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

FIG. 2 is a schematic drawing showing a lateral sectional view of an embodiment while in use according to the present invention.

### DETAILED DESCRIPTION OF THE PREFERRED EMBODIMENT

In order to learn technical features and functions of the present invention, please refer to the following embodiments with detailed descriptions, related figures and reference signs.

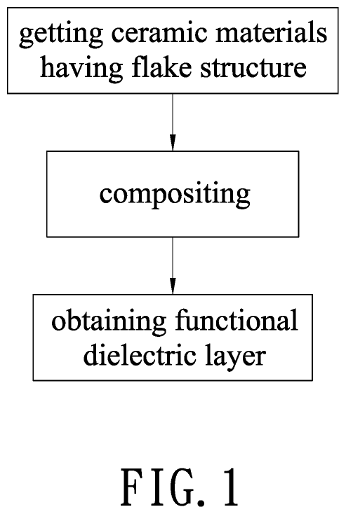

Refer to FIG. 1, a method of manufacturing wire covering materials for prevention of spillover loss during transmission of high frequency or ultra high frequency signals includes the following steps.

A. getting ceramic materials having flake structure: getting high insulating ceramic materials having flake structure in micron-scale or nano-scale while the flake structure can be cubic crystal or pseudocubic crystal. The flake structure has a flake diameter ranging from 0.5 μm to 10 μm and contains 1 to 10 layers while the optimal flake diameter is 5 μm and 1-3 layers are preferred. A thickness of the respective layers of the flake structure is 1 nm-3 nm and 1.5 nm-2 nm is preferred.

B. compositing: performing in-situ composition of the flake structure with non-polar polymers or composition of the flake structure with polymers by a mixer to get paste, granulation, or plastic pellets. A solid content of the paste, granulation, or plastic pellets contains at least 50% the high insulating ceramic materials having the flake structure while 98% is preferred. The paste is prepared by a mixture of the ceramic materials having the maximum diameter of 60 nm with a non-polar dispersant treated by ball milling dispersion for at least 8 hours and 10 hours are preferred. Or the paste is formed by micron-scale ceramic materials having a flake diameter ranging from 110 nm to 1500 nm mixed with a non-polar dispersant and then treated by ball milling dispersion for at least 3 hours while 4 hours are preferred. The optimal flake diameter of the ceramic materials is ranging from 960 nm to 1100 nm.

C. obtaining functional dielectric layer: forming a functional dielectric layer with no gap, no micropore, and low dielectric constant by a manufacturing process such as coating, blow molding, die casting, injection molding, and so on. The functional dielectric layer which looks like plastic is prepared by mixing different materials with functions required at certain ratios and then adjusting paste viscosity by solvents according to requirements for applications to form a film. Thereby the film formed after curing has a thickness of at least 6 μm and an initial temperature of the curing of the film is 100° C.-200° C. which is maintained for at least one minute. The optimal initial temperature is 150° C.

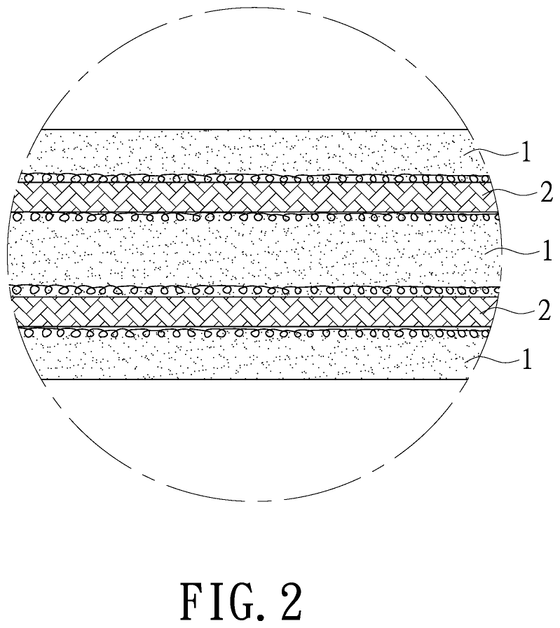

Refer to FIG. 2, a side view of a section of an embodiment is revealed. The functional dielectric layer 1 can be used to cover wires 2 such as Type C 3.0, Type C 3.5, Type C 4.5 and so on, or applied to wrapping of connector (such as RJ45) plugs and sockets. The functional dielectric layer 1 in the form of a film on a contact surface with the wires 2 has a duty ratio which is higher than average value of insulating materials so as to prevent spillover loss during transmission of high frequency or ultra high frequency signals.

In summary, compared with the techniques available now, the present method is more practical in use by using the dielectric layer to cover various types of wires, or connector plugs and sockets for prevention of spillover loss during transmission of high frequency or ultra high frequency signals.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method of manufacturing wire covering materials for prevention of spillover loss during transmission of high frequency or ultra high frequency signals comprising the steps of:
getting ceramic materials having flake structure: getting high insulating ceramic materials having micron-scale or nano-scale flake structure with a flake diameter ranging from 0.5 μm to 10 μm and the flake structure contains 1 to 10 layers each of which having a thickness of 1 nm-3 nm;
compositing: performing composition of the ceramic materials having the flake structure with polymers;
obtaining functional dielectric layer: forming a functional dielectric layer with no gap, no micropore, and low dielectric constant by at least one manufacturing process.

2. The method as claimed in claim 1, wherein in the step A, the flake structure of the high insulating ceramic materials is cubic crystal or pseudocubic crystal.

3. The method as claimed in claim 1, wherein in the step A, a flake diameter of the flake structure is 5 μm.

4. The method as claimed in claim 1, wherein in the step A, the flake structure contains 1 to 3 layers.

5. The method as claimed in claim 1, wherein in the step A, a thickness of each of the layers of the flake structure is 1.5 nm-2 nm.

6. The method as claimed in claim 1, wherein in the step B, in-situ composition of the ceramic materials having the flake structure with non-polar polymers, or composition of the ceramic materials having the flake structure with polymers is performed.

7. The method as claimed in claim 1, wherein in the step B, the composition of the ceramic materials having the flake structure with the polymers is performed by a mixer to get paste, granulation, or plastic pellets.

8. The method as claimed in claim 7, wherein in the step B, a solid content of the paste, granulation, or plastic pellets contains at least 50% the high insulating ceramic materials having the flake structure.

9. The method as claimed in claim 8, wherein in the step B, a solid content of the paste, granulation, or plastic pellets contains 98% the high insulating ceramic materials having the flake structure.

10. The method as claimed in claim 7, wherein in the step B, the paste is gotten by a mixture of the ceramic materials having the maximum diameter of 60 nm with a non-polar dispersant treated by ball milling dispersion for at least 8 hours.

11. The method as claimed in claim 10, wherein in the step B, time for the ball milling dispersion is 10 hours.

12. The method as claimed in claim 7, wherein in the step B, the paste is gotten by the micron-scale ceramic materials having a flake diameter ranging from 110 nm to 1500 nm mixed with a non-polar dispersant and then treated by ball milling dispersion for at least 3 hours.

13. The method as claimed in claim 12, wherein in the step B, the flake diameter of the ceramic materials ranges from 960 nm to 1100 nm.

14. The method as claimed in claim 12, wherein in the step B, time for the ball milling dispersion is 4 hours.

15. The method as claimed in claim 1, wherein in the step C, the functional dielectric layer is obtained by the manufacturing process selected from the group consisting of coating, blow molding, die casting, and injection molding.

16. The method as claimed in claim 1, wherein in the step C, the functional dielectric layer is like plastic.

17. The method as claimed in claim 1, wherein in the step C, viscosity of paste used for obtaining the functional dielectric layer is adjusted by solvents according to requirements for applications to form a film; a thickness of the film formed after curing is at least 6 μm while an initial temperature of the curing of the film is 100° C.-200° C. and the initial temperature is maintained for at least one minute.

18. The method as claimed in claim 17, wherein in the step C, the initial temperature of the curing of the film is 150° C.
